(19) United States
(12) Patent Application Publication
(10) Pub. No.: US 2013/0060546 A1
(43) Pub. Date: Mar. 7, 2013

(54) VISUAL MODELING LANGUAGE FOR REQUIREMENTS ENGINEERING

(71) Applicants: Brian Berenbach, Edison, NJ (US); Jakob Class, Berlin (DE); Florian Schneider, Munchen (DE); Helmut Naughton, Munchen (DE)

(72) Inventors: Brian Berenbach, Edison, NJ (US); Jakob Class, Berlin (DE); Florian Schneider, Munchen (DE); Helmut Naughton, Munchen (DE)

(73) Assignee: Siemens Corporation, Iselin, NJ (US)

(21) Appl. No.: 13/602,574

(22) Filed: Sep. 4, 2012

Related U.S. Application Data
(60) Provisional application No. 61/531,763, filed on Sep. 7, 2011.

(51) Int. Cl. G06G 7/48

(52) U.S. Cl. 703/6

(57) ABSTRACT

A method for generating a computer model representing constraints and desired functions for generating a product or service includes receiving user-selected items including requirements, features, dangers, goals, processes, stakeholders, or objects that are defined by a predetermined meta-model. A data element for each of the selected items received from the user is added to the computer model. A relationship is defined between the data element of the data elements and the defined relationships between the data elements are added to the computer model. The meta-model defines relationships between requirements and features, requirements and dangers, and requirements and goals. A graphical notation library defines a unique descriptive icon for each class of the selected items received from the user.

### CROSS-REFERENCE TO RELATED APPLICATION

The present application is based on provisional application Ser. No. 61/531,763, filed Sept. 7, 2011, the entire contents of which are herein incorporated by reference.

### TECHNICAL FIELD

The present disclosure relates to requirements engineering and, more specifically, to a visual modeling language for requirements engineering.

### DISCUSSION OF THE RELATED ART

Requirements engineering is an interdisciplinary field of engineering focusing on desired functions and constraints of complex combinations of systems and software. In requirements engineering, various factors and objectives are considered and tracked. Requirements engineering may be used to generate a requirements specification, which may be used by systems engineers to aid in design. Modeling is an important tool in requirements engineering. Modeling is the practice by which various aspects of a system may be captured and organized, for example, within a repository such as a database. For example, modeling may be used to capture and organize elements involved in designing a product or service. In modeling a product or process, various software tools may be used to analyze, verify, and validate the design and/or requirements.

The model, once constructed, may be used to generate one or more views for illustrating various facets of the product or service under development so that designers may better conceptualize the state of product development. These views may be embodied as diagrams (e.g. graphs or flow charts) that illustrate the requirement of product features and relationships therebetween.

Modeling languages have been used to provide a consistent approach to requirements modeling. One example of a modeling language is the Systems Modeling Language (SysML). SysML allows for the use of requirements diagrams to capture various requirements for the product or service including requirements affecting function, performance, and interface.

However, as the products and services being designed today grow increasingly sophisticated, models limited to the SysML's notion of requirements may be insufficient to provide a complete view of all the various factors and objectives that are considered in design.

### SUMMARY

A method for generating a computer model representing constraints and desired functions for generating a product or service includes receiving, from a user, a set of selected items including requirements, features, dangers, goals, processes, stakeholders, or objects that are defined by a predetermined meta-model. A data element for each of the desired items received from the user is added to the computer model. A relationship is defined between a first data element of the added data elements and a second data element of the added data elements based on user input and the meta-model. The defined relationships between the first and second data elements are added to the computer model. The meta-model defines relationships between requirements and features, requirements and dangers, and requirements and goals. A graphical notation library defines a unique descriptive icon for each class of the selected items received from the user.

The meta-model may additionally define relationships between goals and features, goals and processes, and goals and stakeholders. The user may select the set of selected items by selecting the corresponding descriptive icon for each item from a display of descriptive icons. The set of selected items may include a goals item representing an outcome desired by a stakeholder. The set of selected items may include a requirements item representing a constraint on the product or service being modeled by the computer model or a desired function of the product or service being modeled by the computer model. The set of selected items may include a features item representing a quality or characteristic desired by a person.

The meta-model may define two categories of dangers, including hazards, which represent risks to health or safety, and threats, which represent risks to financial assets, property, or identity theft. The meta-model may define two categories of processes, including environmental processes that represent a manner in which the modeled product or service is used and use case processes that represent a manner in which the modeled product or service is called into use.

The meta-model and the graphical notation library may define a modeling language.

One or more diagrams may be generated from the computer model based on the meta-model using the unique descriptive icons defined within the graphical notation library.

A method for generating a computer model representing constraints and desired functions for generating a product or service includes displaying a set of unique descriptive icons from a graphical notation library. Each icon is associated with a corresponding item from among requirements, features, dangers, goals, processes, stakeholders, or objects that are defined by a predetermined meta-model. Input indicative of a first user selection from among the displayed icons is received. A first item is added to the computer model based on the received first user input. Input indicative of a second user selection is received from among the displayed icons. A second item is added to the computer model base on the received second user input. A relationship between the first and second item may be defined based on the meta-model. The defined relationship is added to the computer model.

The first item may represent a goal and the second item may represent a feature, process, or stakeholder. The first item may represent a stakeholder and the second item may represent a goal that is an outcome desired by the stakeholder.

The first item may represent a stakeholder and the second item may represent a feature that is a quality or characteristic desired by the stakeholder. Either the first item or the second item may be a danger and the danger may either be a hazard representing a risk to health or safety or a threat representing a risk to property, financial loss, and/or identity theft. Either the first item or the second item may be a process and the process may either be an environmental processes representing a manner in which the modeled product or service is used or a use case process representing a manner in which the modeled product or service is called into use.

One or more diagrams from the computer model may be generated based on the meta-model using the unique descriptive icons defined within the graphical notation library.

A method for generating and presenting a computer model representing constraints and desired functions for generating a product or service includes receiving, from a first user, a set of selected items including features, goals, and functional requirements objects that are defined by a predetermined meta-model. A data element for each of the desired items received from the user is added to the computer model. A view of the computer model in which features and goals objects are included and functional requirements objects are excluded is displayed to a second user. A view of the computer model in which features and goals objects are excluded and functional requirements objects are included is displayed to a third user.

The meta-model may define relationships between requirements and features, requirements and dangers, and requirements and goals and a graphical notation library defines a unique descriptive icon for each class of the selected items received from the first user. Relationships between one or more of the data objects of the computer model may be defined in accordance with input from the first user and the meta-model.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exemplary and simplified meta-model in accordance with exemplary embodiments of the present invention;

FIG. 2 is a flow chart illustrating a method for constructing a requirements model in accordance with exemplary embodiments of the present invention;

FIG. 3 is an exemplary and simplified requirements model in conformance with the meta-model of FIG. 1 in accordance with exemplary embodiments of the present invention;

FIGS. 4A-4F illustrate a meta-model in accordance with exemplary embodiments of the present invention;

FIG. 5 is a graphical notation library in accordance with exemplary embodiments of the present invention; and

FIG. 6 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents, which operate in a similar manner.

Exemplary embodiments of the present invention provide a modeling language for the efficient construction of a requirements model that is capable of capturing and organizing data pertaining to a wide variety of factors, objectives, subjects, and objects associated with the design and requirements of complex products and services, which may be referred to herein as “systems.” For example, exemplary embodiments of the present invention provide a user with an interface within which systems, goals, dangers, features, requirements, processes, people, and things may be inserted into a model. The model may capture relationships between each of the inserted items. The model may then be used to visualize the scope of the requirements specification or to run various software tools to analyze, verify, and/or validate the requirements specification.

Moreover, exemplary embodiments of the present invention may be used to facilitate the practice of Requirements Engineering (RE). Requirements Engineering, as defined by the International Requirements Board, is “A systematic and disciplined approach to the specification and management of requirements with the following goals: (1) Knowing the relevant requirements, achieving a consensus among the stakeholders about these requirements, documenting them according to given standards, and managing them systematically, (2) Understanding and documenting the stakeholders' desires and needs, (3) Specifying and managing requirements to minimize the risk of delivering a system that does not meet the stakeholders' desires and needs.” (Martin Glinz: A Glossary of Requirements Engineering Terminology, Version 1.3 August 2012, available online at http://www.certified-re.de/en/home.html. As this document may be of use in interpreting many of the Requirements Engineering terms used herein, it is incorporated by reference in its entirety.)

It is a feature of exemplary embodiments of the present invention that all of these categories of information, including the aforementioned, may be represented graphically within a single model and thus a modeling language is provided for the capture of these classes of information and others. As explained herein, this new modeling language may be referred to as the Unified Requirements Modeling Language (URML).

The URML may be embodied as a visual modeling language that is specifically tailored to allow for the modeling of all factors involved in requirements engineering within a single model.

In accordance with exemplary embodiments of the present invention, the URML may be embodied as a plug-in or add-on to existing systems engineering tools. Alternatively, the URML may be embodied as a standalone tool. For example, the URML may layer on top of existing modeling languages such as SysML or the Unified Modeling Language (UML).

The URML, in accordance with exemplary embodiments of the present invention, may be used to provide system engineering support for activities that take place prior to system requirements definition, including resolving goal conflicts, identifying and mitigating potential hazards and threats, and specifying features and feature variations in product lines.

Exemplary embodiments of the present invention may provide a user interface with which a user may easily construct a model by, for example, dragging and dropping icons representative of the various elements including goals, dangers, features, requirements, processes, people, and things. Exemplary embodiments of the present invention may provide a meta-model, which serves to define the types of elements that may be included in the model, define the uniquely identifiable graphical icons that represent each element, and dictate the types of relationships that may be provided between elements.

As discussed above, the user may construct or edit a requirements model by selecting one or more icons that graphically represent desired items and placing the selected icons into a workspace that represents the model being constructed or edited. Once in place, the user may define the relationship between the various elements. The relationship may be checked against the meta-model to ensure conformance with the allowable relationships and/or the defining of the relationships by the user may be confined to the allowable relationships set forth in the meta-model so that impermissible relationships cannot be defined in the first place.

In this regard, the meta-model provides a translation from an interface that may be easily understood by an average user to a modeling language that incorporates all the needed concepts of requirements engineering in a single language.

Relationships between elements may either be direct relationships, represented by a single line connecting the two graphically represented elements, or indirect relationships. Indirect relationships are those in which connections are drawn through one or more intervening elements. Indirect relationships between a first and a second element may therefore be represented by a first line connecting the first element to an intermediary element and a second line connecting the intermediary element to the second element. There may also be multiple intermediary elements and in those cases, representation may involve additional lines.

As discussed above, exemplary embodiments of the present invention may be used to graphically represent objects into a single requirements model. Objects may be categorized as belonging to the groups: goals, dangers, features, requirements, processes, people, and things. Each individual class of objects may have its own unique graphical representation and object classes within a single group may have visual similarities but are also uniquely identifiable. While the model objects may be shown as annotated with language, doing so is not necessary as each object class has its own unique graphical representation.

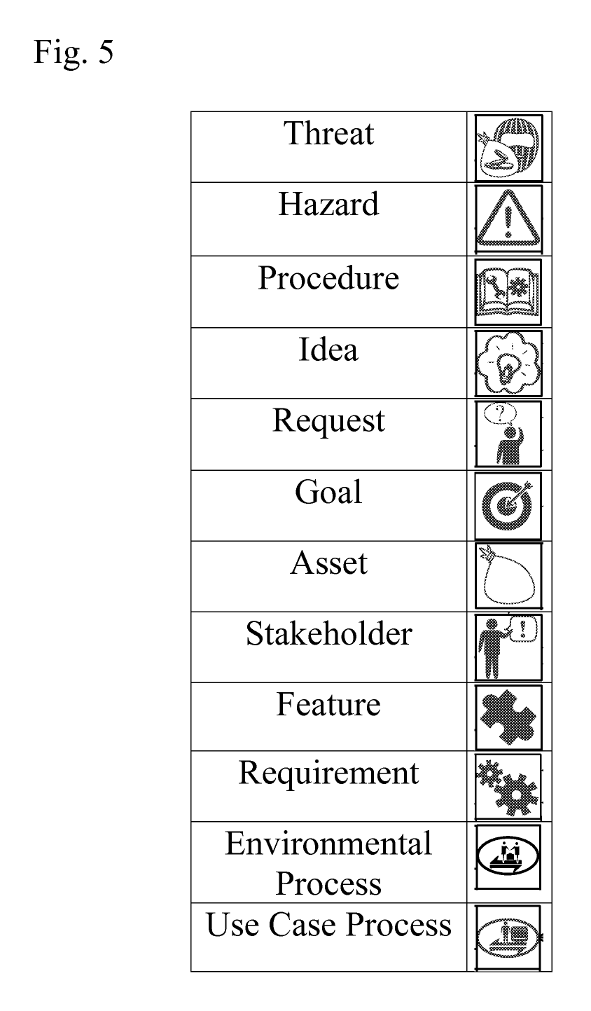

By providing a unique graphical representation of object classes, exemplary embodiments of the present invention may provide semiotic clarity in a systems engineering visual modeling language. This stands in contrast to existing modeling languages in which objects may be expressed as non-expressive geometric shapes. According to exemplary embodiments of the present invention, each unique graphical representation has a form that is suggestive of the purpose and/or function of the object class being represented. For example, as may be seen in FIG. 5, a hazard object may be graphically expressed as a warning triangle with an exclamation mark therein. Greater semiotic clarity may also be provided by graphically representing sub-classes of objects in a manner stylistically consistent with the parent class and/or other sub-classes within the same parent class. For example, a biological hazard may be graphically represented as the same warning triangle as the hazard object with the addition of the biohazard symbol included within the triangle; an electrical hazard may be graphically represented as the warning triangle with a lightning bolt therein; etc.

As used herein, “people” objects may be used to represent anyone that may have an interest in the product or service under design. Accordingly, people objects may be referred to herein as “stakeholders.” Examples of stakeholders may include manufacturers, parts suppliers, customers, retailers, shareholders, etc. Stakeholders may be hierarchically defined within the model.

An “Actor” may be a special class of stakeholders that actually interact with the system being modeled. For example, for a gas turbine system, a field service engineer who services the turbine may be an actor.

Other examples of sub-classes of stakeholders include “customers” who may purchase the system being modeled, “business stakeholders” which may include the builders/sellers of the system being modeled.

While not necessarily people, “service providers” may be included in the model. Service providers may be black box entities, which may provide services to and from the system for which requirements are being modeled. For example, where a product being modeled is a laboratory device, a service provider may be a hospital information system.

As used herein, “goals” objects may be used to represent an outcome desire of any stakeholder. This may be a desired outcome associated with the entry of the product or service being designed into the market place or a desired outcome associated with the use of the product or service being designed. Accordingly, each goal within the model may be relationally connected to a stakeholder. Goals may be identified by a user and then inserted into the model. An example of a goal would be to command a 50% market share with the sale of the product under design. Such a goal may be associated with a manufacturer and/or marketer. Another example of a goal may be to increase productivity by 20%. Such a goal may be associated with a customer/user.

Goals may either be testable or non-testable. A testable goal is one in which satisfaction can be verified. A goal that is non-testable may be referred to herein as a “soft goal.” Testable goals may be associated with test objects that describe a way of testing the testable goal to verify that the goal has been satisfied. An example of a testable goal is to command a 50% market share and the test may include obtaining a market penetration study.

As used herein, “requirements” objects represent any constraint on the product or service under design that may be dictated by contractual obligation, regulatory oversight, physical and/or natural limitation, industry standards, quality standards, etc. each of which may represent a subgroup of requirements. Requirements may be testable and test objects may be included in the model to test for conformance to requirements. Requirements may be defined with specificity and may be objectively and unambiguously understood. Examples of requirements may include vehicle emissions standards.

There may be multiple subgroups of requirements in addition to those described above. For example, “functional requirements” are those requirements that relate to product functionality. There may also be non-functional requirement, which may be referred to herein as “quality requirements.” These elements, rather than affecting product functionality, may influence the manner of production such as efficiency, performance, capacity, operational ranges, maintainability, portability, project execution, reliability, usability, environmental sustainability, etc.

As used herein, “features” objects represent qualities desired by a person such as a customer. Features objects may, more generally, represent characteristics of the system that distinguish it from other systems. Unlike other objects, or to an extent greater than for other objects, features may be those characteristics that customers or marketers use to distinguish competing products in the marketplace. Accordingly, features objects may have an indirect or direct relationship with one or more stakeholders within the model. Features are commonly characteristics desired by a customer, however, a customer need not be aware of the desire in order for the characteristic to be considered a feature. Moreover, actual desire is not necessary for characterization as a feature; it may be sufficient that a stakeholder is assumed to desire the characteristics. Features may be added to the model either as mandatory features or optional features. Features need not be defined objectively or with specificity and accordingly, features may not be testable. An example of a feature may be antilock breaks in an automobile.

While a feature may not be broken down into sub-features, a feature group may be defined as a representation of a certain combination of multiple features.

Features may also give rise to one or more requirements as the inclusion of a feature may introduce one or more requirements into the model. For example, a feature may be WiFi capability and as a result of this feature, a requirement of conformance to IEEE 802.11n standards may be imposed. Accordingly, relationships may exist between requirements and features and these relationships may be included within the model.

Features may be related to goals as particular goals may be satisfied by the introduction of various features. These relationships may be stored within the model.

As discussed above, the “system” may be the product or services being modeled. A product is a subcategory of system that is directed to an article of manufacture. A “product line,” however, may represent a set of products that share one or more features. A “product suite” may represent a set of products that may be used and/or sold together. A single model may include multiple systems, product lines, and/or products.

The URML may capture and record “idea” data objects. Capturing an idea may be used as a basis for the derivation of one or more requirements. This may permit a user viewing a model to trace back to the source and discover the rationale for a related requirement. This may be similar to the way that a requirement might derive from customer or business goals. For example, a stakeholder might mention an idea, which might be the motivation for a request.

As used herein, “ideas” may be an input offered by a stakeholder. Accordingly, an idea may have a relationship with a particular stakeholder included within the model. Ideas may or may not become part of the system being modeled. Where they are incorporated into the system being modeled, it may be through a feature. However, relational connection via a feature is not a requirement as a stakeholder may provide an idea affecting any aspect of the model, with the defining characteristics being its relationship to a stakeholder and its optional implementation. Similarly, a “request” may represent another form of input provided by a stakeholder. An idea and a request may be differentiated based on the intended beneficiary of the input, where a request is understood to include input that benefits the originating stakeholder and thus where a feature is drawn from a request of a stakeholder, that stakeholder is also the beneficiary of that feature.

As used herein, “dangers” objects relate to possible ways in which the product or service under design may pose a risk to people or property or ways on which existing risks to people or property may affect the product or service under design. Dangers may be broken into two subsets including “hazards” which are understood as risks to health or safety and “threats” which are understood as risks to property, financial loss, and/or identify theft. Dangers may be further broken down by cause or nature. For example, hazards may include seismic, meteorological, biological, chemical, radiological, mechanical, electrical, social, etc. Social hazards may include all hazards caused by people and may include theft, cyber-security risk, political risks, etc.

Dangers may be related, either by direct or indirect connection, to stakeholders within the model. For example, a danger may pose a risk to a particular stakeholder. Dangers may also be related to requirements within the model as the requirements may be imposed to remediate or avoid (e.g. mitigate) the included dangers. Stakeholders may also be included in the model by virtue of their role as cause or victim of the danger.

As used herein, “things” elements may be included within the model to represent physical objects such as products and resources. Things may include “entity objects.” Entity objects are things created by or used by the system being modeled. Entity objects may be related to dangers within the model where the thing is, for example, susceptible to a threat or where the thing poses a hazard. One example of an entity object may be a “boundary object.” A boundary object may be part of the system being modeled and may serve as an interface to the outside world.

“Processes” may also be expressed within the model. Exemplary embodiments of the present invention may distinguish between two fundamental types of processes, “environmental processes” and “use case processes.” Each may be added to a model using a unique graphical identifier. Environmental processes relate to the way in which the product or service being designed is called into use while use case processes relate to how the product or service is used. For example, where the product is a CT scanner, an environmental process may include a process of diagnosis and treatment of a patient, within which the CT scanner may be called into use, while a use case process may include the process of operating the CT scanner.

A “mitigating procedure” may also be expressed within the model. A mitigating procedure may be a series of actions intended to reduce or prevent an associated danger.

Some objects within one of the above-described categories may be broken down into constituent objects of the same or different categories. Objects which can be broken down no further may be referred to herein as atomic. Objects that may be further broken down may be referred to herein as composite.

As described above, many different types of relationships between model objects can be established and stored within the model. Relationships may include causal relationships, for example, where a feature causes a hazard or where a goal results in a requirement. Relationships may also express constraint, enablement, harm, uses, triggers, inclusion, exclusion, possession, hierarchy, order, etc.

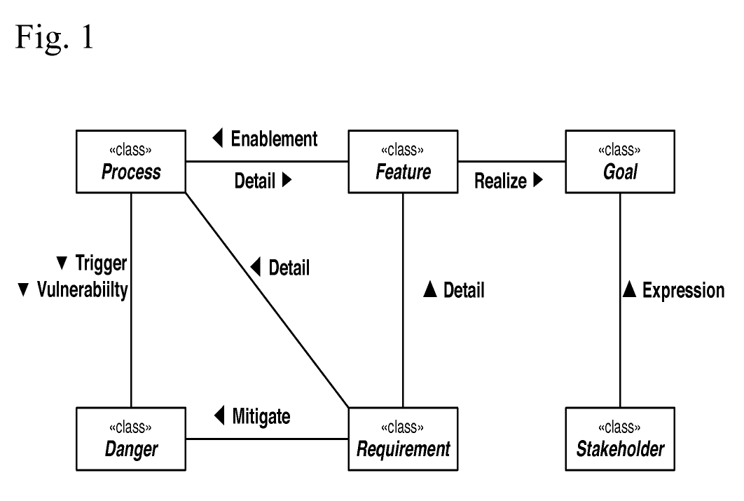

The syntax by which objects and relationships may combine is dictated by the meta-model. FIG. 1 is an exemplary and simplified meta-model in accordance with exemplary embodiments of the present invention. As can be seen from this figure, a stakeholder class of object may be related to a goal class of object. The relationship may be one of expression as the stakeholder may express a goal. The goal class of object may be related to a feature class of object such that the feature realizes the associated goal. A requirement class of object may be related to the feature class of object such that the requirement provides detail for the feature. A process class of object may also be related to a feature class of object such that the process provides detail for the feature and/or the feature is enabled by the process. A requirement class of object may also be related to a process class of object such that the requirement provides detail for the process. A danger class of object may be related to a requirement class of object such that the requirement mitigates the danger. A process class of object may also be related to a danger class of object such that the process triggers the danger and/or the danger represents a vulnerability of the process.

The above-described meta-model is simplified in that additional elements and relationships may be present, however, it is offered as an example of a meta-model in accordance with exemplary embodiments of the present invention.

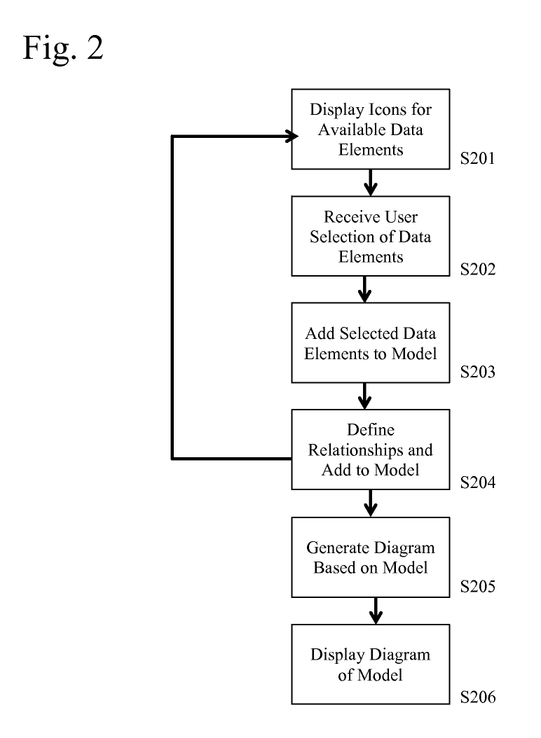

FIG. 2 is a flow chart illustrating a method for constructing a requirements model in accordance with exemplary embodiments of the present invention.

A user interface may be presented to a user intended on constructing a computer model (Step S201). The user interface may include, for example, a display of icons representing available classes of data elements that can be added to the computer model. The icons may be drawn from a library of graphical notation. The user may then select, from the displayed user interface, desired data element classes to add to the model. The user's selection may be received by the user interface (Step S202). The selected data element classes may then be added to the model (Step S203). Relationships between one or more data elements within the model may be defined and these relationships may also be added to the model (Step S204). The relationships may be defined through the user interface. For example the user may draw a line between data elements that have been dragged into a workspace or canvas. The line may be directional and/or a relationship type may be attributed to the line. The directionality of the line and/or the relationship type may either be manually provided by the user or added automatically with reference to the meta-model, which may define types of permissible relationships between particular classes of data elements. Where multiple relationships are permissible, the user may be prompted to select from among them. The above steps S201 through S204 may be repeated for as long as the user has additional data elements and/or relationships to add. The model may also be edited within the user interface. For example, existing data elements and/or relationships may be removed or changed.

After the model has been created, a diagram may be generated based on the model (Step S205). The diagram may be generated as a flow chart, graph or any other expressive image. In generating the diagram, a particular view may be adopted to suit the intended viewer. The view may then be displayed for the intended viewer (Step S206). For example, a high-level product designer may be provided with a view illustrating features and goals while a programmer may be provided with a view illustrating functional requirements.

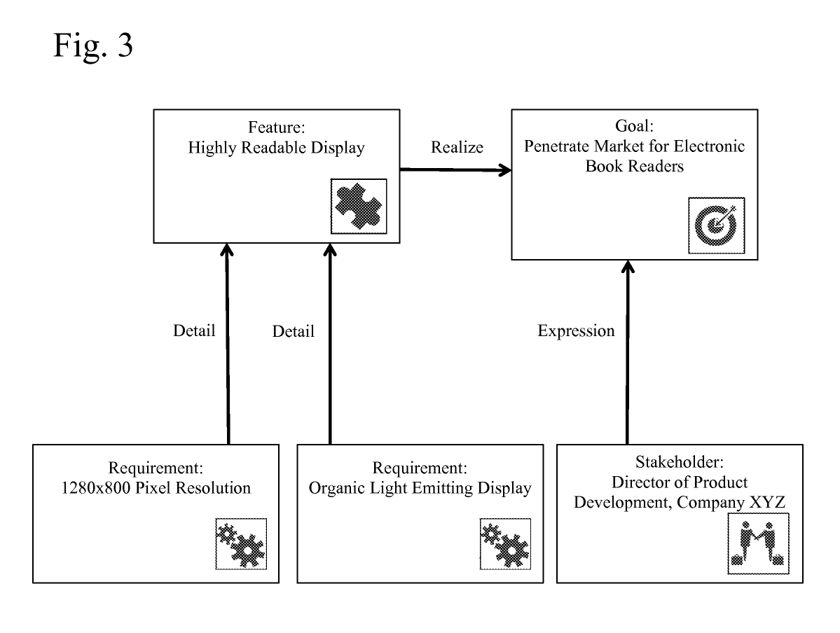

FIG. 3 is an exemplary and simplified requirements model in conformance with the meta-model of FIG. 1 in accordance with exemplary embodiments of the present invention.

It can be seen that the exemplary model of FIG. 3 conforms with the exemplary simplified meta-model of FIG. 1 as each of the included data elements conforms to the set of possible data element categories and each of the relationships between the included data elements abides by the relationships established in the meta-model. For example, the exemplary requirements model includes a stakeholder “director of product development, company XYZ” and a goal “penetrate market for electronic book readers.” The relationship between these two elements is that the stakeholder has expressed the goal. The model also includes a feature “highly readable display.” The relationship between the feature and the goal represents that the feature realizes the goal. The model also includes a first requirement “128×800 pixel resolution.” The relationship between the first requirement and the feature represents that the first requirement provides detail for the feature. The model also includes a second requirement “Organic Light Emitting Display.” The relationship between the second requirement and the feature represents that the second requirement also provides detail for the feature.

Even through the exemplary meta-model only shows one requirement, the fact that the exemplary model contains two requirements is not a departure from the meta-model because the meta-model establishes possible relationships and element classes without regard to the number of actual data elements that may be included in the model. Accordingly, it is also acceptable that the exemplary model does not include danger or process elements as there existence, by virtue of inclusion in the meta-model, is permissible but not mandatory.

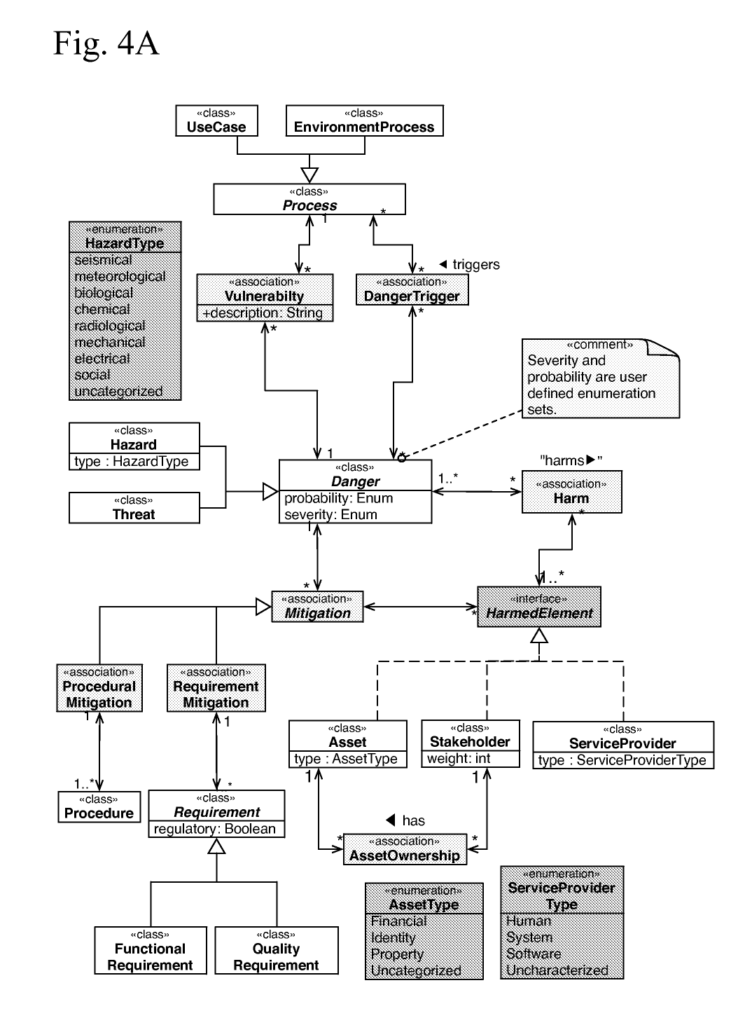

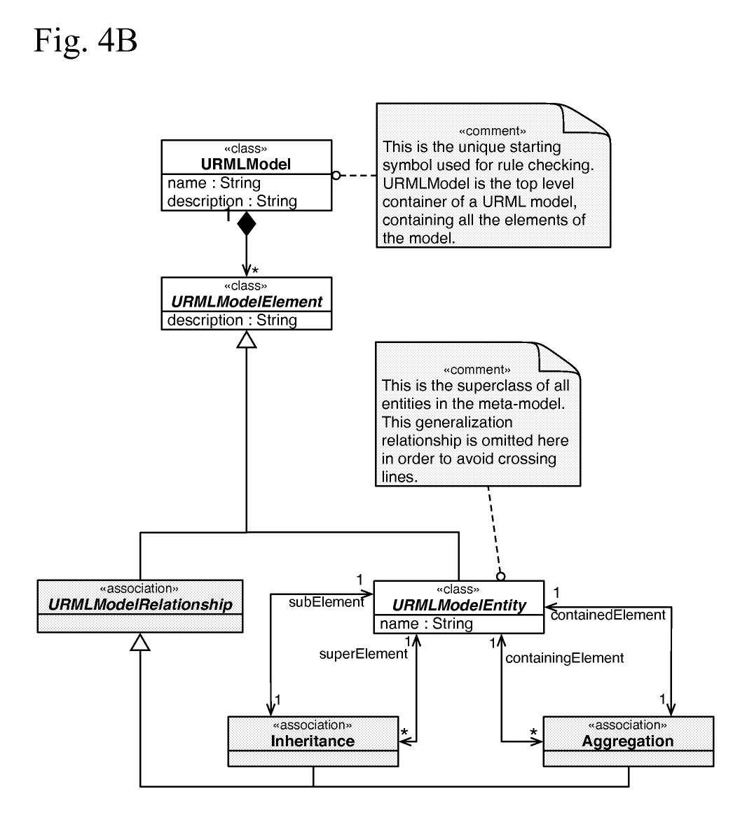

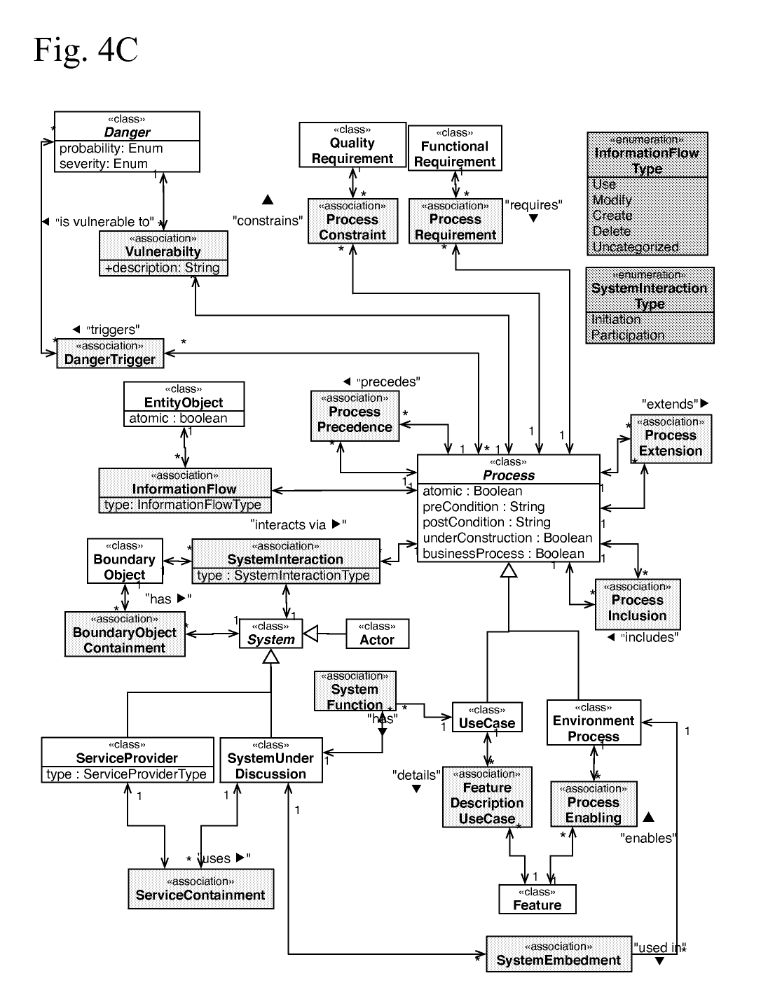

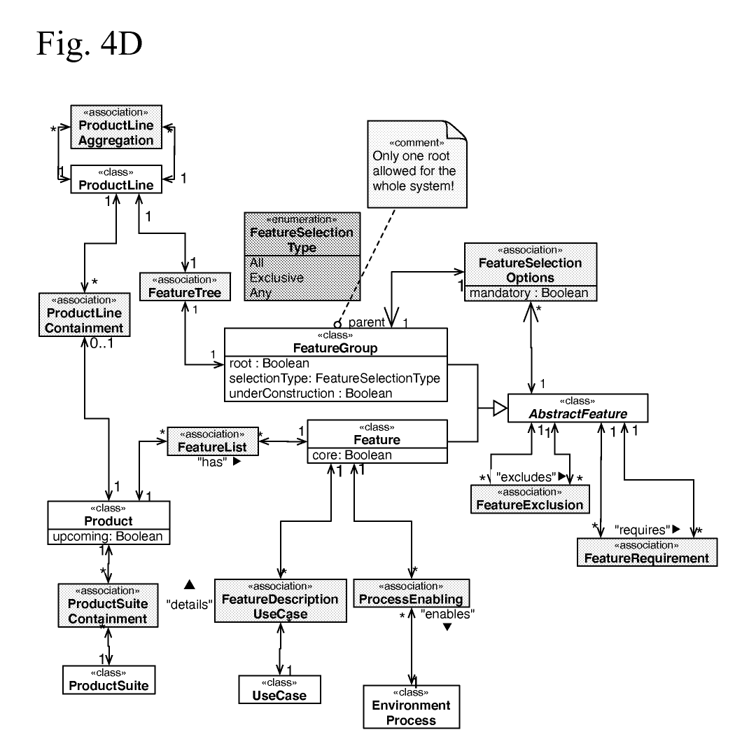

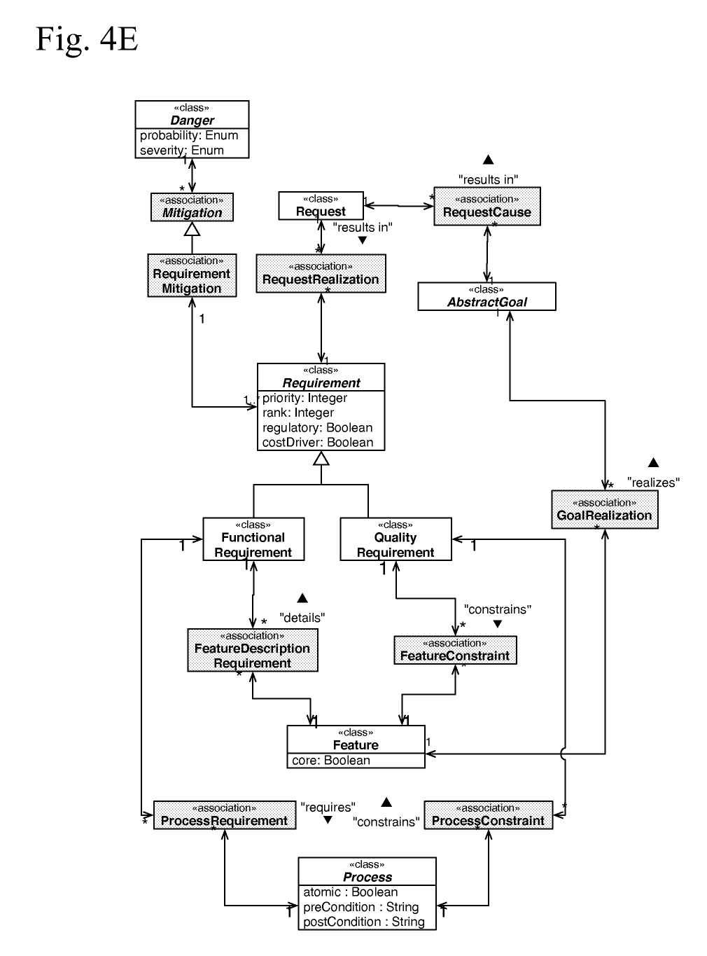

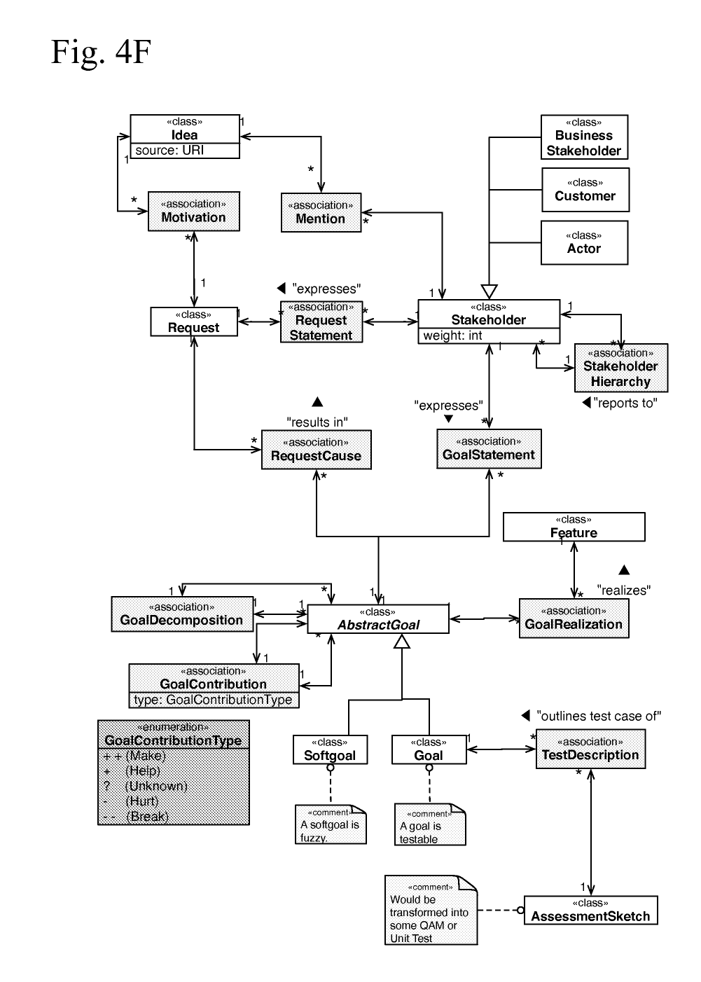

FIGS. 4A-4F provide an exemplary meta-model in accordance with exemplary embodiments of the present invention. The meta-model provided in these figures has been broken up into sections for the purposes of maintaining readability, however, it is to be understood that the meta-model may be provided in a single diagram. It should further be understood that the data elements and relationships illustrated in this exemplary meta-model may be used as part of the URML in accordance with exemplary embodiments of the present invention.

Here, FIG. 4A illustrates a section of the meta-model relating to Danger data elements, FIG. 4B illustrates a section of the meta-model relating to the Kernel of the meta-model, FIG. 4C illustrates a section of the meta-model relating to Process data elements, FIG, 4D illustrates a section of the meta-model relating to Product Line Feature data elements, FIG. 4E illustrates a section of the meta-model relating to Requirements and Rationale data elements, and FIG. 4F illustrates a section of the meta-model relating to Stakeholders and Goals data elements.

FIG. 5 is an exemplary graphical notation library in accordance with exemplary embodiments of the present invention. In this figure, the data elements for Threat, Hazard, Procedure, Idea, Request, Goal, Asset, Stakeholder, Feature, Requirement, Environmental Process, and Use Case Process are presented along with corresponding icons. The icons as defined herein may be used both in the selection of the data elements to be added to the model and for the display of the model thereafter.

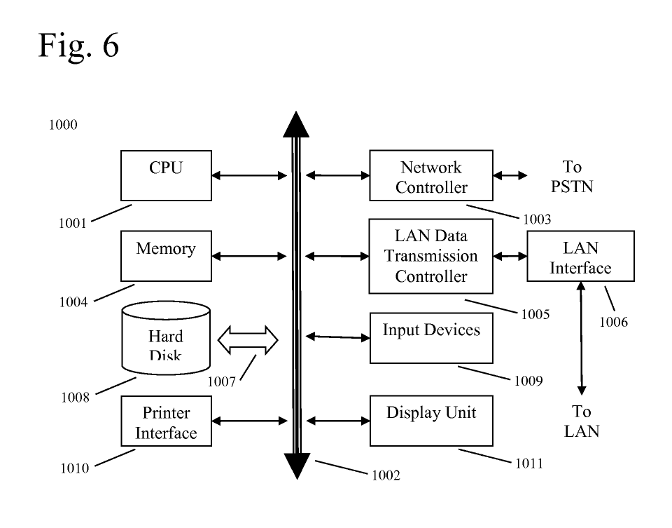

FIG. 6 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for generating a computer model representing constraints and desired functions for generating a product or service, comprising:
receiving, from a user, a set of selected items including requirements, features, dangers, goals, processes, stakeholders, or objects that are defined by a predetermined meta-model;
adding, to a computer model, a data element for each of the selected items, received from the user;
defining a relationship between a first data element of the added data elements and a second data element of the added data elements based on user input and the meta-model; and
adding the defined relationships between the first and second data elements to the computer model,
wherein the meta-model defines relationships between requirements and features, requirements and dangers, and requirements and goals, and
wherein a graphical notation library defines a unique descriptive icon for each class of the selected items received from the user.

2. The method of claim 1, wherein the meta-model additionally defines relationships between goals and features, goals and processes, and goals and stakeholders.

3. The method of claim 1, wherein the user selects the set of selected items by selecting the corresponding descriptive icon for each item from a display of descriptive icons.

4. The method of claim 1, wherein the set of selected items includes a goals item representing an outcome desired by a stakeholder.

5. The method of claim 1, wherein the set of selected items includes a requirements item representing a constraint on the product or service being modeled by the computer model or a desired function of the product or service being modeled by the computer model.

6. The method of claim 1, wherein the set of selected items includes a features item representing a quality or characteristic desired by a person.

7. The method of claim 1, wherein the meta-model defines two categories of dangers, including:
hazards which represent risks to health or safety; and
threats which represent risks to financial assets, property, or identity theft.

8. The method of claim 1, wherein the meta-model defines two categories of processes, including:
environmental processes that represent a manner in which the modeled product or service is used; and
use case processes that represent a manner in which the modeled product or service is called into use.

9. The method of claim 1, wherein the meta-model and the graphical notation library define a modeling language.

10. The method of claim 1, additionally comprising:
generating one or more diagrams from the computer model based on the meta-model using the unique descriptive icons defined within the graphical notation library.

11. A method for generating a computer model representing constraints and desired functions for generating a product or service, comprising:
displaying a set of unique descriptive icons from a graphical notation library, each icon being associated with a corresponding item from among requirements, features, dangers, goals, processes, stakeholders, or objects that are defined by a predetermined meta-model;
receiving input indicative of a first user selection from among the displayed icons;
adding a first item to the computer model based on the received first user input;
receiving input indicative of a second user selection from among the displayed icons;
adding a second item to the computer model base on the received second user input;
defining a relationship between the first and second item based on the meta-model; and
adding the defined relationship to the computer model.

12. The method of claim 11, wherein the first item represents a goal and the second item represents a feature, process, or stakeholder.

13. The method of claim 11, wherein the first item represents a stakeholder and the second item represents a goal that is an outcome desired by the stakeholder.

14. The method of claim 11, wherein the first item represents a stakeholder and the second item represents a feature that is a quality or characteristic desired by the stakeholder.

15. The method of claim 11, wherein either the first item or the second item is a danger and the danger is either a hazard representing a risk to health or safety or a threat representing a risk to financial assets, property, or identity theft.

16. The method of claim 11, wherein either the first item or the second item is a process and the process is either an environmental processes representing a manner in which the modeled product or service is used or a use case process representing a manner in which the modeled product or service is called into use.

17. The method of claim 11, additionally comprising:
generating one or more diagrams from the computer model based on the meta-model using the unique descriptive icons defined within the graphical notation library.

18. A method for generating and presenting a computer model representing constraints and desired functions for generating a product or service, comprising:
receiving, from a first user, a set of selected items including features, goals, and functional requirements objects that are defined by a predetermined meta-model;
adding, to a computer model, a data element for each of the desired items, received from the user;
displaying to a second user a view of the computer model in which features and goals objects are included and functional requirements objects are excluded; and
displaying to a third user a view of the computer model in which features and goals objects are excluded and functional requirements objects are included.

19. The method of claim 18, wherein the meta-model defines relationships between requirements and features, requirements and dangers, and requirements and goals and a graphical notation library defines a unique descriptive icon for each class of the selected items received from the first user.

20. The method of claim 18, wherein relationships between one or more of the data objects of the computer model are defined in accordance with input from the first user and the meta-model.
